(19) United States
(12) Patent Application Publication
(10) Pub. No.: US 2025/0060328 A1
(43) Pub. Date: Feb. 20, 2025

(54) ELECTRODE AND ELECTROCHEMICAL MEASUREMENT SYSTEM

(71) Applicant: NITTO DENKO CORPORATION, Ibaraki-shi, Osaka (JP)

(72) Inventors: Rie HAYASHIUCHI, Ibaraki-shi, Osaka (JP); Motoki HAISHI, Ibaraki-shi, Osaka (JP)

(21) Appl. No.: 18/725,295

(22) PCT Filed: Dec. 16, 2022
(86) PCT No.: PCT/JP2022/046387

§ 371 Date: Jun. 28, 2024

(30) Foreign Application Priority Data
Dec. 28, 2021 (JP) 2021-214866

(51) Int. Cl. G01N 27/30; G01N 27/48

(52) U.S. Cl. CPC G01N 27/308; G01N 27/48

(57) ABSTRACT

An electrode includes a substrate, a metal underlying layer having a melting point of 450° C. or less, and an electrically conductive carbon layer in sequence toward one side in the thickness direction.

### TECHNICAL FIELD

The present invention relates to an electrode and an electrochemical measurement system.

### BACKGROUND ART

There is a known electrode including a substrate, a titanium layer, and an electrically conductive carbon layer in sequence toward one side in the thickness direction (for example, see Patent document 1 below). The electrode of Patent document 1 is provided in an electrochemical measurement system.

### CITATION LIST

### Patent Document

Patent Document 1: Japanese Unexamined Patent Publication No. 2019-105637

### SUMMARY OF THE INVENTION

### Problem to be Solved by the Invention

When an electrode is used as a working electrode for cyclic voltammetry to measure potassium ferricyanide, good sensitivity to potassium ferricyanide is required.

However, the electrode described in Patent Document 1 may not satisfy the above-described requirement.

The present invention provides an electrode and an electrochemical measurement system that have an excellent sensitivity to potassium ferricyanide.

### Means for Solving the Problem

The present invention [1] includes an electrode including: a substrate; a metal underlying layer having a melting point of 450° C. or less; and an electrically conductive carbon layer in sequence toward one side in a thickness direction.

The present invention [2] includes the electrode described in the above-described [1], wherein the metal underlying layer has a raised portion which is raised toward one side in the thickness direction.

The present invention [3] includes the electrode described in the above-described [1] or [2], further including: a second metal underlying layer disposed between the substrate and the electrically conductive carbon layer.

The present invention [4] includes the electrode described in the above-described [3], wherein the substrate, the second metal underlying layer, the metal underlying layer, and the electrically conductive carbon layer are disposed in sequence toward one side in the thickness direction.

The present invention [5] includes the electrode described in any one of the above-described [1] to [4], being an electrode for an electrochemical measurement.

The present invention [6] includes the electrode described in the above-described [5], being a working electrode, wherein the electrochemical measurement is cyclic voltammetry.

The present invention [7] includes an electrochemical measurement system including: the electrode described in the above-described [5] or [6].

### Effects of the Invention

The electrode and electrochemical measurement system of the present invention have an excellent sensitivity to potassium ferricyanide.

### BRIEF DESCRIPTION OF THE DRAWINGS

FIG. 1 is a cross-sectional view of one embodiment of the electrode of the present invention.

FIG. 2 shows the electrode before an electrically conductive carbon layer is formed thereon.

FIG. 3 shows an electrode of a variation.

FIGS. 4A to 4C are image processing views of a cross-sectional TEM picture of Example 3. FIG. 4D is an image processing view of a plan SEM picture of Example 3.

### DESCRIPTION OF THE EMBODIMENT

### 1. One Embodiment of Electrode

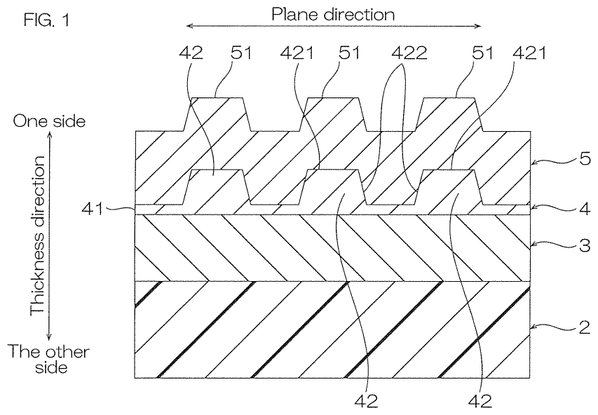

One embodiment of the electrode of the present invention is described with reference to FIG. 1.

An electrode 1 has a thickness. The electrode 1 extends in a plane direction. The plane direction is orthogonal to a thickness direction. Specifically, the electrode 1 has the shape of a sheet. The electrode 1 includes a substrate 2, a second metal underlying layer 3, a metal underlying layer 4, and an electrically conductive carbon layer 5 in sequence toward one side in the thickness direction. In other words, in the electrode 1, the substrate 2, the second metal underlying layer 3, the metal underlying layer 4, and the electrically conductive carbon layer 5 are disposed in sequence toward one side in the thickness direction. In the present embodiment, the electrode 1 includes only the substrate 2, the second metal underlying layer 3, the metal underlying layer 4, and the electrically conductive carbon layer 5.

### 1.1 Substrate 2

The substrate 2 forms the other surface in the thickness direction of the electrode 1. Examples of the material of the substrate 2 include an inorganic material and an organic material. Examples of the inorganic material include silicon and glass. Examples of the organic material include polyester, polyolefin, acryl, and polycarbonate. Examples of the polyester include polyethylene terephthalate (PET) and polyethylene naphthalate.

As the material of the substrate 2, preferably an organic material is used, more preferably polyester is used, and even more preferably PET is used. When the material of the substrate 2 is an organic material, the substrate 2 is a flexible film. The substrate 2 has a thickness of, for example, 2 μm or more, preferably 20 μm or more and, for example, 1000 μm or less, preferably 500 μm or less.

### 1.2 Second Metal Underlying Layer 3

The second metal underlying layer 3 is disposed on one surface of the substrate 2 in the thickness direction. Specifically, the second metal underlying layer 3 is in contact with the one surface of the substrate 2 in the thickness direction. The second metal underlying layer 3 extends in the plane direction.

Furthermore, the second metal underlying layer 3 is also a metal layer having a high melting point. The second metal underlying layer 3 has a melting point of, for example, 500° C. or more, preferably 1000° C. or more, more preferably 1250° C. or more. The second metal underlying layer 3 has a melting point of, for example, 2000° C. or less. Specifically, examples of the material of the second metal underlying layer 3 include a conductor having a high melting point. Examples of the conductor having a high melting point include titanium. The second metal underlying layer 3 has a thickness of 50 nm or less, preferably 35 nm or less and, for example, 1 nm or more, preferably 3 nm or more.

1.3 Metal Underlying Layer 4

In the present embodiment, the metal underlying layer 4 is disposed on one surface of the second metal underlying layer 3 in the thickness direction. That is to say, the metal underlying layer 4 is disposed at one side of the substrate 2 in the thickness direction through the second metal underlying layer 3. The metal underlying layer 4 is disposed at a side opposite to the substrate 2 with respect to the second metal underlying layer 3 in the thickness direction. Specifically, the metal underlying layer 4 is in contact with the one surface of the second metal underlying layer 3.

The metal underlying layer 4 integrally has a flat portion 41 and a raised portion 42.

The flat portion 41 is in contact with the one surface of the second metal underlying layer 3. In the present embodiment, one flat portion 41 is provided per metal underlying layer 4.

The raised portion 42 is raised from one end edge of the flat portion 41 toward one side in the thickness direction. A plurality of raised portions 42 is provided per flat portion 41. The raised portions 42 are separated from each other by an interval in the plane direction. Each of the raised portions 42 has an approximately trapezoidal shape in a cross-sectional view along the thickness direction. One surface of the raised portion 42 in the thickness direction has a first surface 421 and a second surface 422.

One first surface 421 is provided per raised portion 42. The first surface 421 extends in the plane direction.

Two second surfaces 422 are included in one raised portion 42 in the cross-sectional view. The second surface 422 is continuous to an end portion of the first surface 421 in the plane direction and one surface of the flat portion 41 in the thickness direction. The second surface 422 has a tapered shape. The two tapers facing each other in the cross-sectional view are inclinations having a cross-sectional area along the plane direction gradually becoming smaller toward one side in the thickness direction.

The metal underlying layer 4 has a melting point of 450° C. or less. Thus, the metal underlying layer 4 is a metal layer having a low melting point.

On one hand, when the metal underlying layer 4 has a melting point of more than 450° C., an excellent sensitivity to potassium ferricyanide cannot be achieved.

On the other hand, in the present embodiment, the melting point of the metal underlying layer 4 is preferably 400° C. or less, more preferably 320° C. or less, even more preferably 300° C. or less, furthermore, preferably 250° C. or less, 245° C. or less, 240° C. or less. When the melting point of the metal underlying layer 4 is the above-described upper limit or less, a more excellent sensitivity to potassium ferricyanide can be achieved.

The lower limit of the melting point of the metal underlying layer 4 is not limited. The metal underlying layer 4 has a melting point of, for example, 100° C. or more, preferably 150° C. or more, more preferably 200° C. or more.

Examples of the material of the metal underlying layer 4 include a conductor having a low melting point. Specifically, examples of the conductor having a low melting point include tin, indium, lead, zinc, cadmium, selenium, thallium, lithium, bismuth, and an alloy thereof. Examples of the alloy include ITM (tin indium alloy). In view of cost, environmental burden, safety, handling (such as processing), as the conductor having a low melting point, tin, indium, and ITM are preferably used, tin is more preferably used.

The flat portion 41 has a thickness of, for example, 1 nm or more, preferably 2 nm or more and, for example, 20 nm or less, preferably 10 nm or less. The raised portion 42 has a thickness of, for example, 5 nm or more, preferably 10 nm or more and, for example, 200 nm or less, preferably 150 nm or less, more preferably 75 nm or less, even more preferably 40 nm or less, particularly preferably 25 nm or less.

The metal underlying layer 4 has a thickness of, for example, 1 nm or more, preferably 3 nm or more, more preferably 5 nm or more and, for example, 100 nm or less, preferably 50 nm or less, more preferably 15 nm or less. The thickness of the metal underlying layer 4 is a sum of the thickness of the flat portion 41 and the thickness of the raised portion 42.

When the thickness of the metal underlying layer 4 is the above-described lower limit or more, the surface resistance of the electrode 1 can be reduced. When the thickness of the metal underlying layer 4 is the above-described upper limit or less, noise in an electrochemical measurement can be reduced. Specifically, the capacitance can be reduced in a CV measurement of potassium ferricyanide.

### 1.4 Electrically Conductive Carbon Layer 5

The electrically conductive carbon layer 5 is disposed on one surface of the metal underlying layer 4 in the thickness direction. Specifically, the electrically conductive carbon layer 5 is in contact with the one surface of the metal underlying layer 4 in the thickness direction. The electrically conductive carbon layer 5 extends in the plane direction. The electrically conductive carbon layer 5 has electrical conductivity.

The electrically conductive carbon layer 5 has a shape following that of the metal underlying layer 4. In the present embodiment, the electrically conductive carbon layer 5 has a second raised portion 51 corresponding to the raised portion 42 of the metal underlying layer 4.

In the present embodiment, the electrically conductive carbon layer 5 has a graphite structure and a diamond structure. Furthermore, the electrically conductive carbon layer 5 is allowed to contain a trace of inevitable impurities other than oxygen.

The electrically conductive carbon layer 5 has a thickness of, for example, 0.1 nm or more, preferably 1 nm or more and, 100 nm or less, preferably 50 nm or less.

### 1.5 Method of Producing Electrode 1

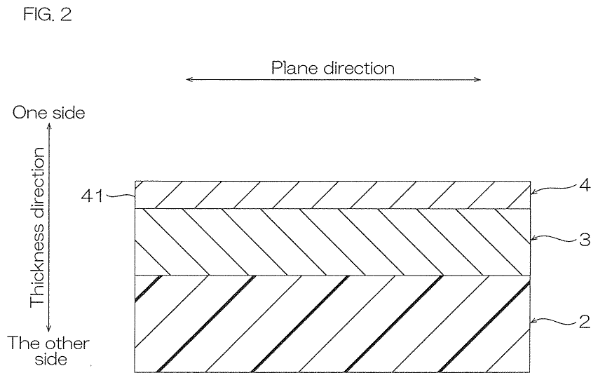

Next, with reference to FIGS. 1 and 2, a method of producing the electrode 1 is described. In this method, first, a substrate 2 is prepared. Next, a second metal underlying layer 3, a metal underlying layer 4, and an electrically conductive carbon layer 5 are formed in sequence toward one side in the thickness direction, relative to the substrate 2.

To form the second metal underlying layer 3 on one surface of the substrate 2 in the thickness direction, for example, a dry method, preferably sputtering is used. In sputtering, for example, the above-described conductor having a high melting point is used as a target. Examples of the sputtering include magnetron sputtering, magnetron sputtering, and pulsed sputtering. Magnetron sputtering is preferably used.

The sputtering is carried out using a sputtering device. The sputtering device includes the above-described target, a chamber, a vacuum exhaust member, and a gas supply member. The target is connected to a power source. The chamber includes the target, the vacuum exhaust member, and the gas supply member at the inside thereof. The chamber defines a sputtering room. The vacuum exhaust member reduces the pressure in the chamber. The gas supply member supplies a sputtering gas into the chamber.

In the sputtering, while the pressure in the chamber is reduced with the vacuum exhaust member, a sputtering gas is supplied from the gas supply member into the chamber. At the same time, electricity is applied to the target.

To form the metal underlying layer 4 on one surface of the second metal underlying layer 3 in the thickness direction, for example, a dry method, preferably sputtering is used. In sputtering, for example, the above-described conductor having a low melting point is used as a target. Examples of the sputtering include the same methods as described above.

Through this step, as shown in FIG. 2, the metal underlying layer 4 made of the flat portion 41 is formed on the one surface of the second metal underlying layer 3. The metal underlying layer 4 formed in this step does not have a raised portion 42 (see FIG. 1) yet.

To form the electrically conductive carbon layer 5 on one surface of the metal underlying layer 4 in the thickness direction, for example, a dry method, preferably sputtering is used. In sputtering, for example, carbon (specifically, sintered carbon) is used as a target. Examples of the sputtering include the same methods as described above. Magnetron sputtering is preferably used.

Through this step, the electrically conductive carbon layer 5 is formed on the one surface of the metal underlying layer 4 in the thickness direction, and a raised portion 42 is formed on the metal underlying layer 4. The raised portion 42 is presumed to be formed by the coagulation of the conductor having a low melting point in the flat portion 41 in a dry method (specifically, sputtering) for forming an electrically conductive carbon layer 5.

In this manner, an electrode 1 is produced.

The electrode 1 has a surface resistance of, for example, 2000Ω/□ or less, preferably 1000Ω/□ or less, more preferably 300Ω/□ or less, even more preferably 150Ω/□ or less, and 1Ω/□ or more. The surface resistance is measured by a method with a four-point probe array in conformity with JIS K 7194.

### 1.6 Uses of Electrode 1

Next, the uses of the electrode 1 is described. The electrode 1 can be used as various types of electrodes, preferably as an electrode for an electrochemical measurement to carry out an electrochemical measurement method, specifically, as a working electrode (working electrode) to carry out cyclic voltammetry (CV). In such a case, the above-described electrode 1 is included in an electrochemical measurement system.

The electrochemical measurement system includes a reference electrode, a counter electrode (Pt), and a potentiostat in addition to the above-described electrode 1 as a working electrode. The reference electrode is, for example, Ag/AgCl. The counter electrode is, for example, Pt. The potentiostat is connected to the electrode 1, the reference electrode, and the counter electrode.

Examples of an object to be measured with the electrode 1 include potassium ferricyanide (potassium hexacyanoferrate).

In particular, the electrode 1 is highly active when an aqueous solution containing potassium ferricyanide is measured. That is to say, the electrode 1 has high sensitivity to potassium ferricyanide. This can be seen by the fact that the redox potential difference ΔEp in the CV measurement is low.

### 2. Operations and Effects of One Embodiment

The electrode 1 includes the metal underlying layer 4 having a melting point of 450° C. or less. Thus, the electrode 1 has excellent sensitivity to potassium ferricyanide.

When the metal underlying layer 4 has a raised portion 42, the electrically conductive carbon layer 5 can also have a second raised portion 51 following the raised portion 42 of the metal underlying layer 4. Therefore, due to the second raised portion 51 in the electrically conductive carbon layer 5, the surface area of the electrically conductive carbon layer 5 increases. As a result, the sensitivity to potassium ferricyanide is presumed to be excellent.

Accordingly, when cyclic voltammetry is carried out using the electrochemical measurement system including the above-described electrode 1 as a working electrode, excellent sensitivity to potassium ferricyanide is achieved.

### 3. Variations

In the variations, the same members and steps as in one embodiment are given the same numerical references, and the detailed descriptions thereof are omitted. Further, the variations can have the same operations and effects as those of one embodiment unless especially described otherwise. Furthermore, one embodiment and the variations can appropriately be combined.

### 3.1 First Variation

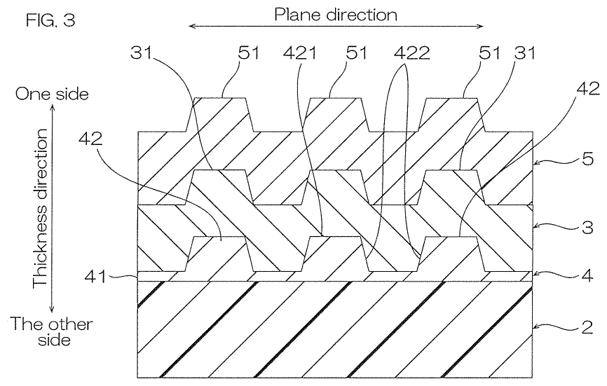

As shown in FIG. 3, the electrode 1 includes a substrate 2, a metal underlying layer 4, a second metal underlying layer 3, and an electrically conductive carbon layer 5 in sequence toward one side in the thickness direction.

In the first variation, the second metal underlying layer 3 has a shape following the metal underlying layer 4, and has a raised portion 31 corresponding to the raised portion 42 of the metal underlying layer 4.

In comparison of one embodiment with the first variation, one embodiment is preferable. The electrode 1 of one embodiment can lower the surface resistance and lower the noise in an electrochemical measurement. Specifically, the capacitance can be lowered in a CV measurement of potassium ferricyanide.

### 3.2 Second Variation

In the second variation, although not shown, the metal underlying layer 4 does not have a raised portion 42. The metal underlying layer 4 includes only a flat portion 41.

### 3.3 Third Variation

In the third variation, although not shown, the electrode 1 does not include a second metal underlying layer 3. The electrode 1 of the third variation includes a substrate 2, a metal underlying layer 4, and an electrically conductive carbon layer 5 in sequence toward one side in the thickness direction. That is to say, in this variation, the substrate 2, the metal underlying layer 4, and the electrically conductive carbon layer 5 are disposed in sequence toward one side in the thickness direction. The metal underlying layer 4 is in contact with the one surface of the substrate 2 in the thickness direction.

### EXAMPLES

With reference to Examples and Comparative Examples, the present invention is more specifically described below. The present invention is not limited to Examples and Comparative Examples in any way. The specific numeral values used in the description below, such as blending ratios (content ratios), physical property values, and parameters, can be replaced with the corresponding blending ratios (content ratios), physical property values, and parameters in the above-described “DESCRIPTION OF THE EMBODIMENT”, including the upper limit values (numeral values defined with “or less” or “less than”) or the lower limit values (numeral values defined with “or more” or “more than”).

### Production of Electrode Using Sputtering Device A

### Examples 1 to 4, Examples 6 and 7, Examples 9 to 14, and Comparative Example 1

### Example 1

A substrate 2 made of polyethylene terephthalate and having a thickness of 50 μm was prepared.

Next, using DC magnetron sputtering, a second metal underlying layer 3 made of titanium was formed on one surface of the substrate 2 in the thickness direction. The conditions for the DC magnetron sputtering were as follows.
Targeted material: titanium
Shape and Size of Target: 2-inch diameter cylindrical shape
Target power: 150 W
Sputtering gas: Argon
Pressure in the sputtering chamber: 0.3 Pa

The second metal underlying layer 3 had a thickness of 12 nm.

Next, as shown in FIG. 2, using RF magnetron sputtering, a metal underlying layer 4 made of tin was formed on one surface of the second metal underlying layer 3 in the thickness direction. The conditions for the RF magnetron sputtering were as follows.
Targeted material: tin
Shape and Size of Target: 2-inch diameter cylindrical shape
Target power: 100 W
Sputtering gas: Argon
Pressure in the sputtering chamber: 0.3 Pa

As shown in FIG. 2, the metal underlying layer 4 had only a flat portion 41. The metal underlying layer 4 had a thickness of 2.5 nm. That is to say, the target thickness of the metal underlying layer 4 was 2.5 nm.

Thereafter, as shown in FIG. 1, using DC magnetron sputtering, an electrically conductive carbon layer 5 was formed on one surface of the metal underlying layer 4 in the thickness direction. The conditions for the DC magnetron sputtering were as follows.
Targeted material: sintered carbon
Shape and Size of Target: 2-inch diameter cylindrical shape
Argon Gas Pressure: 0.3 Pa
Target power: 150 W

The electrically conductive carbon layer 5 had a thickness of 10 nm. Furthermore, through this step, as shown in FIG. 1, a raised portion 42 was formed on the metal underlying layer 4.

### Examples 2 to 4, Examples 6 and 7, Examples 9 to 14, and Comparative Example 1

Except that the following points were changed, an electrode 1 was produced using a sputtering device A in the same manner as Example 1.

### Examples 2 to 4 and Examples 11 to 14

In accordance with Table 1, the target thickness of the metal underlying layer 4 was changed.

### Example 6

In accordance with Table 1, the order of forming the second metal underlying layer 3 and the metal underlying layer 4 was inverted. That is to say, first the metal underlying layer 4 was formed, and subsequently the second metal underlying layer 3 was formed.

### Example 7

In accordance with Table 1, the order of forming the second metal underlying layer 3 and the metal underlying layer 4 was inverted. Furthermore, in accordance with Table 1, the target thickness of the metal underlying layer 4 was changed.

### Example 9

In place of tin as the targeted material, ITM containing tin in a ratio of 15% by mass was used. Furthermore, in accordance with Table 1, the target thickness of the metal underlying layer 4 was changed.

### Example 10

In place of tin as the targeted material, indium was used. Furthermore, in accordance with Table 1, the target thickness of the metal underlying layer 4 was changed.

### Comparative Example 1

A metal underlying layer 4 was not formed.

### Production of Electrode Using Sputtering Device B

### Example 5, Example 8, and Comparative Example 2

### Example 5

A substrate 2 made of polyethylene terephthalate and having a thickness of 50 μm was prepared.

Next, using DC magnetron sputtering, a second metal underlying layer 3 made of titanium was formed on one surface of the substrate 2 in the thickness direction.
Targeted material: titanium
Shape and Size of Target: 6-inch diameter cylindrical shape
Target power: 100 W
Sputtering gas: Argon
Pressure in the sputtering chamber: 0.2 Pa

The second metal underlying layer 3 had a thickness of 12 nm.

Next, as shown in FIG. 2, using DC magnetron sputtering, a metal underlying layer 4 made of tin was formed on one surface of the second metal underlying layer 3 in the thickness direction. The conditions for the DC magnetron sputtering were as follows.
Targeted material: tin
Shape and Size of Target: 6-inch diameter cylindrical shape
Target power: 80 W
Sputtering gas: Argon
Pressure in the sputtering chamber: 0.2 Pa

As shown in FIG. 1, the metal underlying layer 4 had only a flat portion 41. The metal underlying layer 4 had a thickness of 10 nm. That is to say, the target thickness of the metal underlying layer 4 was 10 nm. Thereafter, using DC pulsed sputtering, the electrically conductive carbon layer 5 was formed on one surface of the metal underlying layer 4 in the thickness direction. The conditions for the DC pulsed sputtering were as follows.
Targeted material: sintered carbon
Shape and Size of Target: 6-inch diameter cylindrical shape
Argon Gas Pressure: 0.4 Pa
Target power: 400 W
Pulse Width: 0.4 μs
Frequency: 150 kHz

The electrically conductive carbon layer 5 had a thickness of 10 nm. Furthermore, through this step, as shown in FIG. 1, a raised portion 42 was formed on the metal underlying layer 4.

### Example 8 and Comparative Example 2

Except that the following points were changed, an electrode 1 was produced using a sputtering device B in the same manner as Example 5.

### Example 8

In accordance with Table 1, the order of forming the second metal underlying layer 3 and the metal underlying layer 4 was inverted. That is to say, first the metal underlying layer 4 was formed, and subsequently the second metal underlying layer 3 was formed.

### Comparative Example 2

A metal underlying layer 4 was not formed.

### <Evaluations of Physical Properties of Electrode 1>

With respect to the electrode 1 of each of Examples and Comparative Examples, the following physical properties were evaluated. The results are shown in Table 1.

### <Presence or Absence of Raised Portion 42 by Observation of TEM Picture and Observation of SEM Picture>

Observation of a cross-sectional TEM picture of the electrode 1 and observation of a plan SEM picture of the electrode 1 were carried out. In this manner, whether or not the metal underlying layer 4 had a raised portion 42 and whether or not the electrically conductive carbon layer 5 had a second raised portion 51 were determined.

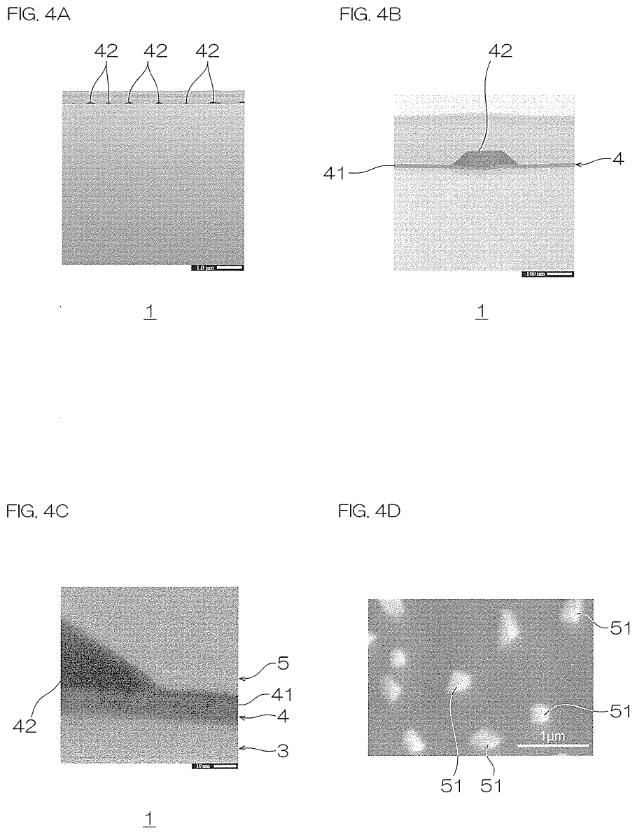

A cross-sectional TEM picture of Example 3 is shown in FIGS. 4A to 4C. A plan SEM picture of Example 3 is shown in FIG. 4D.

### <Sensitivity to Ferricyan Activity (Measurement of Redox Potential Difference ΔEp)>

An insulating tape was attached onto one surface of the electrically conductive carbon layer 5 in the thickness direction. The insulating tape had a 2-mm diameter hole. The electrode area exposed from the hole was 0.0314 cm². In this manner, an electrode 1 was produced as a working electrode. The electrode 1 was connected to a potentiostat (IVIUM Technologies, pocketSTAT). Separately, a reference electrode (Ag/AgCl) and a counter electrode (Pt) were prepared, and connected to the potentiostat. In this manner, an electrochemical measurement system was assembled.

Next, the working electrode was inserted into a potassium chloride solution in which K₄[Fe(CN)₆] was dissolved. The concentration of potassium chloride in the solution was 1.0 mol/L. The concentration of K₄[Fe(CN)₆] in the solution was 1.0 mmol/L. In the same manner as described above, each of the reference electrode (Ag/AgCl) and the counter electrode (Pt) was inserted into the potassium chloride solution. Thereafter, a CV measurement was carried out in a potential range of −0.1 V to 0.5 V at a scan rate of 0.1 V/sec. The potential difference ΔEp at a redox peak was obtained as a ferricyan activity value.

### <Noise During Measurement (Capacitance Measurement)>

An insulating tape was attached onto one surface of the electrically conductive carbon layer 5 in the thickness direction. The insulating tape had a 2-mm diameter hole. The electrode area exposed from the hole was 0.0314 cm². In this manner, an electrode 1 was produced as a working electrode. The electrode 1 was connected to a potentiostat (IVIUM Technologies, pocketSTAT). Separately, a reference electrode (Ag/AgCl) and a counter electrode (Pt) were prepared, and connected to the potentiostat. In this manner, an electrochemical measurement system was assembled.

Next, in this manner, the electrode 1 was produced as a working electrode. The working electrode was inserted into a 1.0 mol/L potassium chloride solution. Furthermore, each of the reference electrode (Ag/AgCl) and the counter electrode (Pt) was inserted into the potassium chloride solution. Next, a CV measurement was carried out in a potential range of 0 V to 0.5 V at a scan rate of 0.01 V/sec. The capacitance value was calculated by substituting the values into the following formula.

Capacitance Value [μF/cm²]=(Sum of Absolute Values of Two Current Values at 0.25V) [μA]/2×0.01[V/sec]/0.0314 [cm²]

The fact that capacitance value is low means that the noise is low.

TABLE 1
Table 1

| | | | | | | | Presence or | | | |
|---|---|---|---|---|---|---|---|---|---|---|
| | | | | | | | absence of | Presence or | Ferricyan | |
| | | | | Second | Metal underlying | | raised | absence of | activity | |
| | | | | Metal | layer | | portion | raised | value Redox | Noise during |
| | | | Corre- | underlying | Targeted | | on metal | portion | potential | measurement |
| Ex./ | Sputtering | Formation | sponding | layer | Thickness* | | underlying | on conductive | difference | Capacitance |
| Comp. Ex. | device | order | FIG. | Material | [nm] | Material | layer | carbon layer | ΔEp [V] | [μF/cm2] |
| Ex. 1 | A | Second metal | FIG. 1 | Titanium | 2.5 | Tin | Presence | Presence | 0.11 | 9 |
| | | underlying layer | | | | | | | | |
| | | →Metal under- | | | | | | | | |
| | | lying layer | | | | | | | | |
| Ex. 2 | A | Second metal | FIG. 1 | Titanium | 5 | Tin | Presence | Presence | 0.11 | 8 |
| | | underlying layer | | | | | | | | |
| | | →Metal under- | | | | | | | | |
| | | lying layer | | | | | | | | |
| Ex. 3 | A | Second metal | FIG. 1 | Titanium | 10 | Tin | Presence | Presence | 0.08 | 5 |
| | | underlying layer | | | | | | | | |
| | | →Metal under- | | | | | | | | |
| | | lying layer | | | | | | | | |
| Ex. 4 | A | Second metal | FIG. 1 | Titanium | 20 | Tin | Presence | Presence | 0.09 | 18 |
| | | underlying layer | | | | | | | | |
| | | →Metal under- | | | | | | | | |
| | | lying layer | | | | | | | | |
| Ex. 5 | B | Second metal | FIG. 1 | Titanium | 10 | Tin | Presence | Presence | 0.08 | 13 |
| | | underlying layer | | | | | | | | |
| | | →Metal under- | | | | | | | | |
| | | lying layer | | | | | | | | |
| Ex. 6 | A | Metal under- | FIG. 3 | Titanium | 2.5 | Tin | Presence | Presence | 0.11 | 12 |
| | | lying layer | | | | | | | | |
| | | →Second metal | | | | | | | | |
| | | underlying layer | | | | | | | | |
| Ex. 7 | A | Metal under- | FIG. 3 | Titanium | 10 | Tin | Presence | Presence | 0.10 | 24 |
| | | lying layer | | | | | | | | |
| | | →Second metal | | | | | | | | |
| | | underlying layer | | | | | | | | |
| Ex. 8 | B | Metal under- | FIG. 3 | Titanium | 10 | Tin | Presence | Presence | 0.09 | 14 |
| | | lying layer | | | | | | | | |
| | | →Second metal | | | | | | | | |
| | | underlying layer | | | | | | | | |
| Ex. 9 | A | Second metal | FIG. 1 | Titanium | 10 | [TM | Presence | Presence | 0.10 | 10 |
| | | underlying layer | | | | | | | | |
| | | →Metal under- | | | | | | | | |
| | | lying layer | | | | | | | | |
| Ex. 10 | A | Second metal | FIG. 1 | Titanium | 10 | Indium | Presence | Presence | 0.09 | 11 |
| | | underlying layer | | | | | | | | |
| | | →Metal under- | | | | | | | | |
| | | lying layer | | | | | | | | |
| Ex. 11 | A | Second metal | FIG. 1 | Titanium | 30 | Tin | Presence | Presence | 0.10 | 13 |
| | | underlying layer | | | | | | | | |
| | | →Metal under- | | | | | | | | |
| | | lying layer | | | | | | | | |
| Ex. 12 | A | Second metal | FIG. 1 | Titanium | 50 | Tin | Presence | Presence | 0.11 | 13 |
| | | underlying layer | | | | | | | | |
| | | →Metal under- | | | | | | | | |
| | | lying layer | | | | | | | | |
| Ex. 13 | A | Second metal | FIG. 1 | Titanium | 100 | Tin | Presence | Presence | 0.10 | 14 |
| | | underlying layer | | | | | | | | |
| | | →Metal under- | | | | | | | | |
| | | lying layer | | | | | | | | |
| Ex. 14 | A | Second metal | FIG. 1 | Titanium | 200 | Tin | Presence | Presence | 0.10 | 60 |
| | | underlying layer | | | | | | | | |
| | | →Metal under- | | | | | | | | |
| | | lying layer | | | | | | | | |
| Comp. | A | Second metal | — | Titanium | — | — | Absence | Absence | 0.14 | 7 |
| Ex. 1 | | underlying | | | | | | | | |
| | | layer only | | | | | | | | |
| Comp. | B | Second metal | — | Titanium | — | — | Absence | Absence | 0.10 | 9 |
| Ex. 2 | | underlying | | | | | | | | |
| | | layer only | | | | | | | | |

Thickness*Thickness of the metal underlying layer before a raised portion is formed

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The electrode is used, for example, for an electrochemical measurement system.

### DESCRIPTION OF REFERENCE NUMERALS

1 electrode
2 substrate
3 second metal underlying layer
4 metal underlying layer
42 raised portion
5 electrically conductive carbon layer

1. An electrode comprising: a substrate; a metal underlying layer having a melting point of 450° C. or less; and an electrically conductive carbon layer in sequence toward one side in a thickness direction.

2. The electrode according to claim 1, wherein the metal underlying layer has a raised portion which is raised toward one side in the thickness direction.

3. The electrode according to claim 1, further comprising:
a second metal underlying layer disposed between the substrate and the electrically conductive carbon layer.

4. The electrode according to claim 3, wherein the substrate, the second metal underlying layer, the metal underlying layer, and the electrically conductive carbon layer are disposed in sequence toward one side in the thickness direction.

5. The electrode according to claim 1, being an electrode for an electrochemical measurement.

6. The electrode according to claim 5, being a working electrode, wherein the electrochemical measurement is cyclic voltammetry.

7. An electrochemical measurement system comprising: the electrode according to claim 5.
